(19) United States
(12) Patent Application Publication
(10) Pub. No.: US 2016/0269403 A1
(43) Pub. Date: Sep. 15, 2016

(54) MULTI-FACTOR USER AUTHENTICATION

(71) Applicant: Wiacts Inc., Sunnyvale, CA (US)

(72) Inventors: Bamshad Azizi Koutenaei, Arlington, VA (US); Yaser Masoudnia, San Jose, CA (US)

(21) Appl. No.: 15/069,677

(22) Filed: Mar. 14, 2016

Related U.S. Application Data
(60) Provisional application No. 62/132,396, filed on Mar. 12, 2015.

(51) Int. Cl. H04L 29/06

(52) U.S. Cl. CPC H04L 63/0861; H04L 63/0428; H04L 63/102; H04L 63/0838

(57) ABSTRACT

Embodiments of the present invention relates to a multi-factor authentication system and method using an authentication device, a browsing device and an authentication server. Authentication requires a user to keep an authentication device within a certain proximity of a browsing device, and to authenticate locally to the authentication device using biometric information. The biometric information of the user is stored locally in the authentication device to prevent the need to transmit sensitive biometric information to an authentication server. The authentication server is capable of detecting unusual activity based on information received from the authentication device and the browsing device.

### CROSS REFERENCE TO RELATED APPLICATIONS

The present application claims benefit under 35 USC 119 (e) of U.S. provisional Application No. 62/132,396, filed Mar. 12, 2015 entitled “Multi-Factor User Authentication” which is incorporated herein by reference in its entirety.

### BACKGROUND OF THE INVENTION

In typical authentication systems a user is authenticated by a service or an application using single factor authentication, such as a user name and password. Alphanumeric passwords continue to be the most common method of user authentication. However, when used as the sole form of authentication passwords are easily susceptible to malicious attacks. When a password is stolen or used with authorization, it creates problems for the user of a server and the provider of that service. Typical authentication systems use passwords and/or usernames to authenticate a user.

### BRIEF SUMMARY

Various embodiments of the present invention disclose a secure multi-factor authentication system and method that utilizes an authentication device to authenticate a user to a browsing device using biometric information. This multi-factor authentication system is more secure than typical authentication systems, because it requires user authentication via biometric information to an authentication device and it also requires the authentication device to be within a certain proximity of the browsing device.

According to an embodiment of the present invention a method is for authenticating a user comprises of receiving a request from the user to access an account via a browsing device, acquiring biometric data from the user via an authentication device, and granting access to the account based on the biometric data. In some embodiments, the authentication of a user is based on the proximity between a browsing device and a second device.

According to an embodiment of the present invention a method for authenticating a user may comprise generating a first encrypted message using an authentication device, decrypting the first encrypted message by an authentication server, and authenticating the user based on the contents of the decrypted message. In some embodiments, the first encrypted message contains a randomly generated time and location password. In one embodiment, a second encrypted message may be generated using the authentication device and the second encrypted message is decrypted using the browsing device. In some embodiments, the second encrypted message may contain account information related to a user's account.

According to an embodiment of the present invention a method for authenticating a user may comprise generating a third encrypted message via a browsing device, decrypting the third encrypted message via an authentications server, and authenticating the user based on the contents of the decrypted message.

### BRIEF DESCRIPTION OF THE FIGURES

Reference will now be made to the accompanying drawings, which are not necessarily drawn to scale, and wherein:

FIG. 1 illustrates an exemplary login process according to one embodiment of the invention;

FIG. 2 illustrates an exemplary initial set up process according to one embodiment of the invention;

FIG. 3 illustrates an exemplary authentication process according to one embodiment of the invention;

FIG. 4 illustrates an exemplary system according to one embodiment of the invention;

FIG. 5 illustrates an exemplary login process according to another embodiment of the invention;

FIG. 6 illustrates an exemplary initial setup process according to another embodiment of the invention;

FIG. 7 illustrates an exemplary authentication process according to another embodiment of the invention;

FIG. 8 illustrates an exemplary initial setup process according to another embodiment of the invention;

FIG. 9 illustrates an exemplary authentication process according to another embodiment of the invention;

FIG. 10 illustrates an exemplary initial setup process according to another embodiment of the invention;

FIG. 11 illustrates an exemplary authentication process according to another embodiment of the invention; and

FIG. 12 illustrates an exemplary system according to one embodiment of the invention.

### DETAILED DESCRIPTION OF THE INVENTION

Embodiments of the present invention may be implemented in many ways, including as a process, a method, a system, a computer network, a service, and the like. Some embodiments of the present invention relate to user authentication in order to either grant or deny access to the user on the user's computerized device (computer, PC, laptop or tablet, and the like)—herein referred to as the “browsing device”—using a biometric reader available on the computerize device. In accordance with one embodiment of the present invention, a user may be granted or denied access to an application, software, account, virtual private network, or a computing device. In some embodiments of the invention, after an initial setup a user is no longer required to enter in a password to be authenticated. Instead the user will be authenticated using biometric information. In another embodiment, granting or denying access to the user using a browsing device may be performed in coordination with another device (such as smartphone or smart wearable device)—herein referred to as the “authentication device”—that is in the proximity of the browsing device. In one example, a pair of devices may be considered to be in each other's proximity if they are within a predefined range of each other. In another example, a pair of devices may be considered to be in each other's proximity if they are connected to the same WiFi/LAN network, same cellular network, and the like. In yet other embodiments, a pair of devices may be considered to be in each other's proximity if they are able to send and receive Bluetooth beacons.

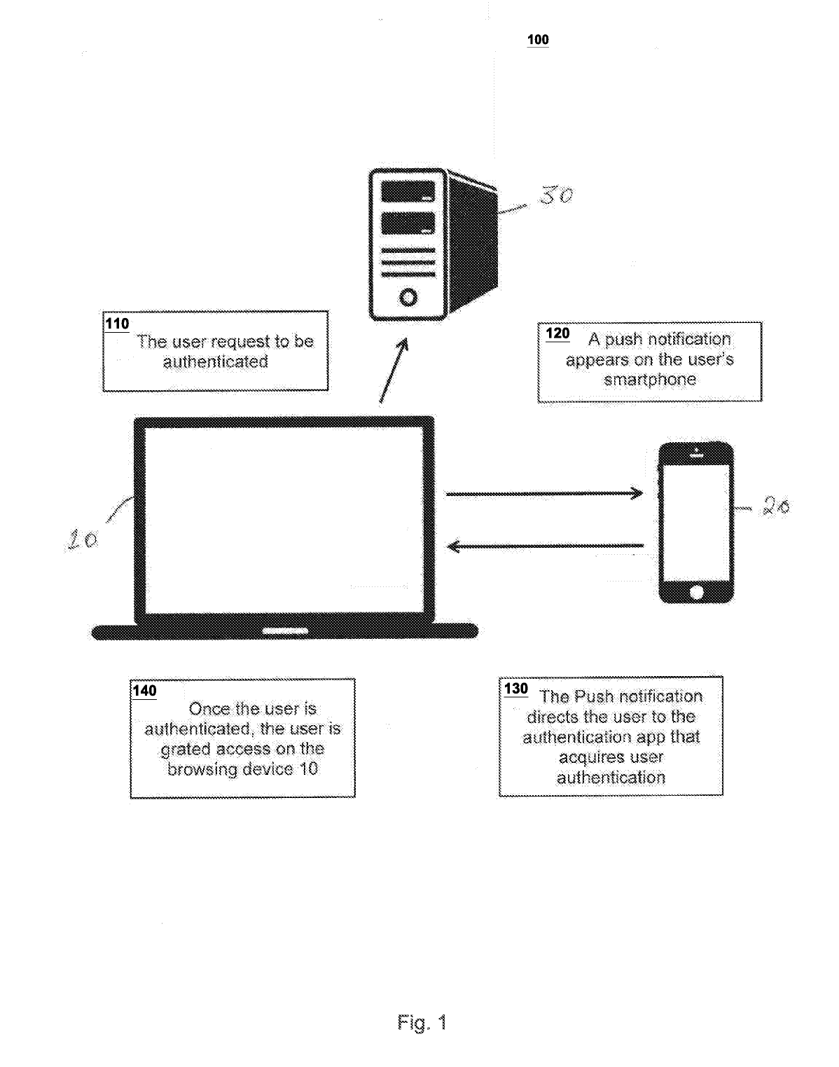

Referring to FIG. 1, browsing device 10 and authentication device 20 may be typically two separate devices. However if the browsing device 10 is able to securely authenticate the user by acquiring the user's biometric information, the presence of separate authentication device 20 may not be not necessary. The communication between authentication and browsing devices may be done via any number of protocols or techniques, such as Bluetooth, Wi-Fi, ad hoc network, intranet, Internet, and the like. In addition, there may be an authentication server 30 that the authentication device 20 and the browsing device 10 may need to communicate with in order to complete the authentication process.

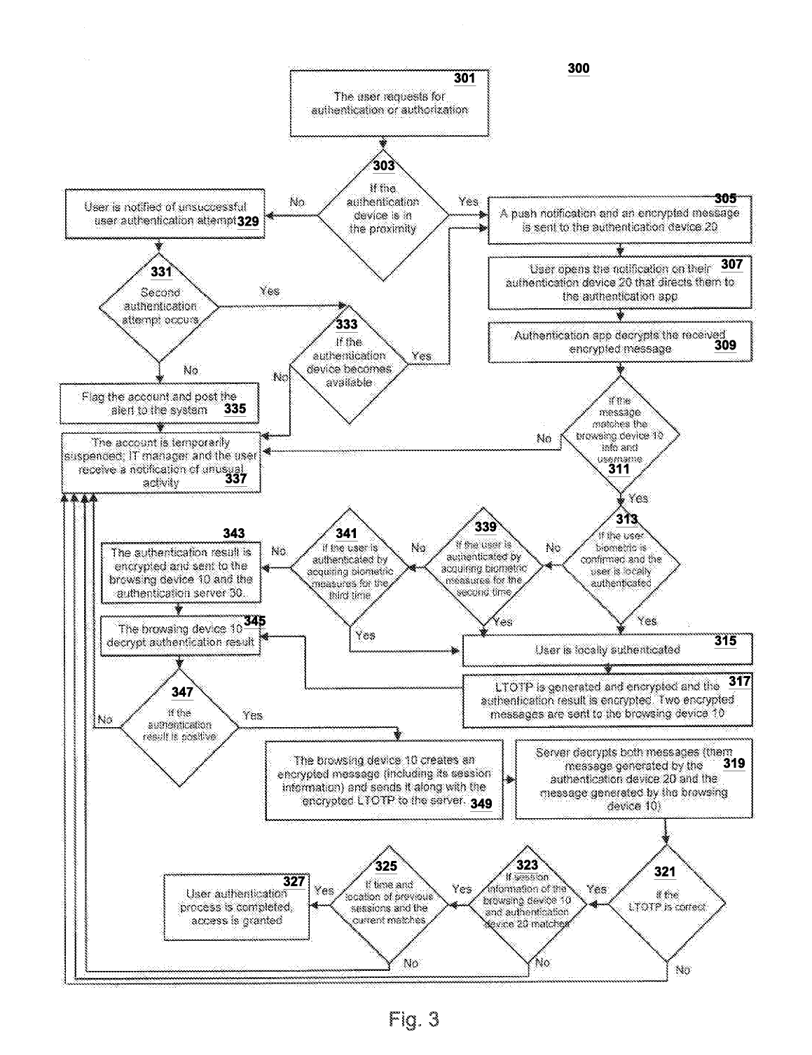

Generally, the order of steps and the trigger of authentication process may be altered based on the scale and scope of implementation, client existing infrastructures, and desired level of security. Four different exemplary embodiments of the present invention are described below. But it is understood that the embodiments of the present invention are applicable to many other situations. Furthermore, embodiments of the present invention are not limited to any specific number of, for example, attempts made by a user during, e.g., biometric acquisition or any other authentication-related activity. For example, while the flowchart in FIG. 3 shows that a user's biometric information may be acquired during three attempts, it is understood that this is only an example and that the embodiments of the present invention are not so limited.

### First Embodiment

FIG. 1 illustrates system 100 according to a first embodiment of the invention. In this embodiment, the authentication process is triggered from browsing device 10 at 110. For instance, the user, using his/her browsing device 10 opens an application, a website, an online account, and the like, that the user desires to login to, for example, to authorize an online transaction, or add a recipient to his/her online bank account, or authorize another device as the authentication or the browsing device 10, and the like. In any of the above cases or similar circumstance, after the user enters the username or other required information—if it is applicable—and clicks on the login, sign-in, submit, and the like, button on the browsing device 10, the user's biometric information is invoked to be acquired on the authentication device 20. At 120, a notification may be pushed to the user's previously registered authentication device 20 that is in the proximity of the browsing device for such biometric acquisition. At 130, the user opens the notification on the authentication device 20 directing the user to supply the biometric information. At 140, if the user's biometric information matches the record, as stored, for example, in the authentication device, the authentication device 20 communicates with the server (e.g. the authentication server 30) to inform server 30 of the match. Thereafter, the user is authenticated and access to the user is granted on the browsing device 10.

Embodiments of the present invention use an existing setup of an authentication device 20 to check for a user's biometric information if the authentication device has already been configured to perform for this operation. In the event that the user has not set up the biometric reader on his/her authentication device 20, during the initial setup step (once the user opens the authentication application for the first time) the biometric information of the user is acquired and securely stored (i.e. encrypted by software and/or hardware and/or stored in a secured element (e.g. trusted hardware/memory, trusted platform module (TPM), secured partition of memory and the like) in the authentication device 20 for future reference. Every time a user tries to get authenticated, the authentication process based on biometric happens locally on the authentication device 20. Therefore, biometric information of the user is not stored on the authentication server 30 and is not transferred between devices and servers.

### Initial Setup

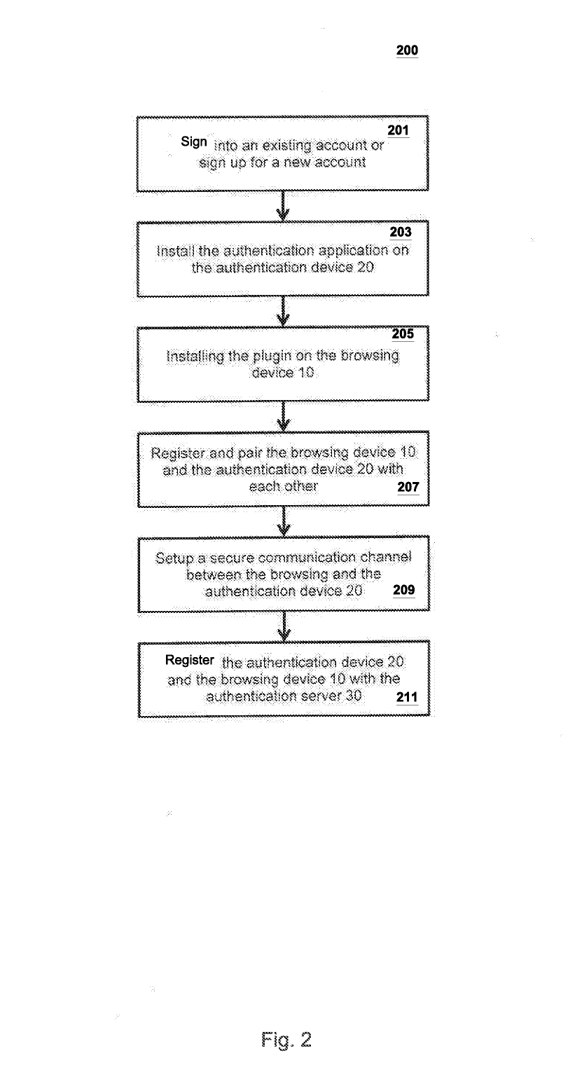

FIG. 2, illustrates a process 200 for an initial set up according to an embodiment of the present invention. Prior to process 200, in order to set up this multi-factor authentication (MFA), the user needs to assign a device as the browsing device 10 and another device as the authentication device 20. As described above, if the browsing device 10 is able to read the user's biometric information—such as fingerprint, voice, face image, finger geometry, heart electrocardiogram (ECG) biometric, vein patterns, Iris pattern, and the like—the browsing device 10 may also be used as the authentication device 20.

At 201, if the user is an existing user, the user logs into the account, application, webpage, single sign-on portal, and the like on his/her browsing device 10 using an existing solution (e.g. username and password). If the user is a new user, the user sign-up process may be similar to that for an existing user. However, the first time user may not have any account, application, or webpage to log into. To make the process secure, the first time user may receive an email or a message on one of his/her devices (the browsing or the authentication device)—and may be asked to follow the steps described below. This makes the sign-up process “invite only” which may be desirable to improve security.

At 203, the user downloads and installs the authentication application on the assigned authentication device 20. This process may start manually or triggered by scanning a barcode such as a quick response (QR) code that is shown on the screen of the browsing device 10.

Optionally, at 205, the user may need to add software or application for the browsing device 10. This application designed for the browsing device 10 may include a plugin for Internet browser or the application. If the user uses a computer device that load its program from a server, the browsing device 10 application or relevant plugin may be loaded from the server.

Once the authentication application is downloaded and opened for the first time, the authentication application acquires the user's biometric information. Once the user is locally authenticated for the first time based on the acquired biometric, at 207, the application on the authentication device 20 and the browsing device 10 must be registered and paired. This process may be executed manually or automated by scanning a barcode such as a QR barcode or by presenting the user with a time based one-time password and asking the user to enter that number into the authentication application on his/her authentication device.

At 209, a secure communication channel is established between the user's browsing device 10 and the authentication device 20. This communication channel may be established via any number of protocols or techniques, such as cable, Bluetooth, Wi-Fi, Ad-hoc network, Near Field Commination channel, and the like. Through the process of registering two devices, the authentication application may utilize public key cryptography, create a pair of public and private keys, and send the public key to the browsing device. The provided private key is securely stored on the user's authentication device. In addition to public/private key encryption methods, other cryptography techniques such as Pretty Good Privacy (PGP) may be used for secure communication between devices and the authentication server.

At 211, the authentication device 20 and the browsing device 10 are registered with the authentication server 30 thereby to complete the initial setup process, in accordance with one embodiment. In some embodiments, the registration of two devices is completed through creating two pair of private and public keys. Both devices store the private key and send the public key to the authentication server. The browsing device may send device information such as the type of device, device name, Mac ID, hardware information, browser name, browser version, operating system, operating system version, IP, agent operating system, browser size, and the like, to the authentication server as a registration process. The authentication device may also send device information such as GPS information, location information of WiFi, cell tower info that the authentication device communicates with, latent signals, Mac ID, WiFi Mac ID, WiFi Network SSID, Bluetooth Low Energy Mac ID, nearby BLE Devices Mac ID, SSID, hardware information of the authentication device, Intentional Mobile station Equipment Identity (IMEI), operating system, operating system version, screen resolution, touch screen pattern while users was using the authentication device, user behavior including motion sensors information, phone number of the authentication device, whether the authentication device is jailbroken/rooted, and the like, to the authentication server. All the communication between the browsing device, the authentication device, and the authentication server may be encrypted. Once the initial setup process is completed and the user logs out from his/her account, this authentication process may be executed in order to perform the login operation.

At the conclusion of 211, whenever the user authenticates, he/she will no longer authenticate using their old authentication method (as described in step 201). Instead the user will provide their biometric information, without manually entering a password, to be authenticated locally to the authentication device.

### Authentication Process

FIG. 3 illustrates an authentication or authorization process 300 according an embodiment of the present invention after the user has completed the initial setup, therefore, the browsing device 10 and the authentication device 20 are already paired and a secure communication channel has been setup between them. Therefore, every time the two devices are in proximity of each other and the user takes (at 301) an action on his/her browsing device 10 that requires authentication or authorization (for instance, log into an application, online account, webpage, VPN, a computing device, the browsing device and the like) the browsing device 10 requests to start communicating with the authentication device 20.

At 303, once the user performs an action that requires user authentication or authorization (e.g. opens an application or software tries to log into an account or a webpage, and the like) the browsing device 10 first checks if the authentication device 20 is in its proximity. To do this, the browsing device connects to the authentication device and if it is in its proximity, it sends a challenge to the authentication device. The authentication device receives that challenge and signs it with its private key and send it back to the browsing device. The method of checking proximity depends on the initial setup, the specific application, and/or desired level of security. If the communication channel between the browsing device 10 and authentication device 20 is setup over a Wi-Fi network, both devices could be connected to the same network. If this communication is done through an ad-hoc network, the ad-hoc network must be launched manually or automatically. If this channel is based on Bluetooth, the proximity is measured via beacon of Bluetooth and two devices can be automatically paired. This communication may also be set via Near Field Communication (NFC), or any number of protocols and techniques.

At 329, if the authentication device 20 is determined not to be in proximity of the browsing device 10 and the browsing device 10 is not able to directly communicate via assigned channel, the browsing device 10 flags the account as at risk and alerts the authentication server 30. The user will also be notified that an unsuccessful attempt of authentication or authorization has been made on the user's behalf. At 331, based on desired level of security and the user may be allowed to try again to be authenticated. In such cases, if the second attempt to get authenticated (or authorized) occurs and the authentication device 20 is not yet in the proximity of browsing device 10 and the browsing device 10 fails to communicate with the authentication device 20, then at step 335, the browsing device 10 alerts the authentication server 30 or other server as it applies. At 337, the IT administration (or any relevant person), and the user is alerted that the account is at risk. Consequently, this may result in limiting access to the account, webpage, and the like or temporary or permanently suspending any action that needs users' authentication or authorization. The number of attempts to get user authentication or authorization (e.g. at 331) can be set from one to any desirable number by the IT administration.

At 331, after a first, second or more (if it is authorized by IT administration) attempts at 333, it is determined that the authentication device 20 is in proximity of the browsing device 10 and if the browsing device 10 and the authentication device 20 are able to communicate, at 305, the browsing device 10 sends a push notification with an encrypted message (including a challenge) to the authentication device 20. At 307, the push notification directs the user to the authentication application. Alternatively, the authentication application only receives an encrypted message and the notification may not be send, if this is desirable. In such cases, the user may open the authentication application 20 manually.

At 309, the authentication application decrypts the message received from the browsing device 10. At 311, if it is determined that the message contains information that doesn't match the user and the browsing device 10 information (previously registered in the application), then the process proceeds to 337 where the application notifies the authentication server 30 and/or the IT manager about the unusual request received from the browsing device 10. This flags the account and/or the username as being at risk which may result in limiting access to the account, webpage, application, software, and the like or temporary or permanently suspending any actions that needs users' authentication or authorization.

If at 311 it is determined that the message contains information that matches user information and browsing device 10, then the process moves to 313 and the authentication application acquires user's biometric. No matter if the authentication device 20 has a screen lock activated that asks for biometric to unlock the screen or not; once the user opens the authentication application, the authentication application acquires user biometric. Based on the operating system and hardware available on authentication device 20, the authentication application acquires any type of biometric, such as fingerprint, voice, face image, finger geometry, heart ECG biometric, vein patterns, Iris pattern, and the like that is available on the device.

In accordance with embodiments of the present invention, at 311, the process of being authenticated by biometric is executed locally on the authentication device 20 and within the authentication application. No biometric information is saved on the server or any other devices. In order to maintain privacy of user's biometric information, the sample of user biometric is only recorded in the authentication device 20 and preferably in the secured element. All the information corresponding to the user's biometric information that is recorded on the device is encrypted.

Based on the desired level of security, IT administration may be able to set the number of time that a user can try to get locally authenticated through getting biometric information. In one embodiment, this number may be set to three times. Therefore, in such embodiments, the user is only able to provide the user's biometric information two more times if the first attempt fails.

At 313, if the local user authentication process via checking biometric fails the first time, then at 339, the user may be given a second chance to authenticate via acquired biometrics. If the user is not successfully authenticated at 339, then at 341 the user may be given a third chance to authenticate via acquired biometrics After three times, if the user is not locally authenticated on the device based on the user's biometric, then at 337, the authentication device 20 sends negative results to the browsing device 10 and the authentication server 30. This flags the account and/or the username as being at risk which may result in limiting access to the account, webpage, application, software, and the like or—temporary or permanently—suspending any actions that needs users' authentication or authorization.

If the actions at 313, 339 or 341 are successful, then at 315, the local user authentication process via checking biometrics is completed successfully and the user is authenticated. Next at 317, the authentication device 20 creates two encrypted messages including a first message for the browsing device 10 and a second message for the authentication server 30. Both messages have a challenged signed by the authentication device's 20 private key. Then the authentication device 20 sends both encrypted messages to the browsing device 10. The encrypted first message that was created for the browsing device 10 includes the authentication device 20 session information, MAC ID, and the signed challenge by the private key. The second encrypted message generated by the authentication application for the authentication server 30 includes a signed challenge by the authentication device's 20 private key, device information may be included in the first and/or second encrypted message such as location information of WiFi, cell tower info that the authentication device communicates with, latent signals, Mac ID, WiFi Mac ID, WiFi Network SSID, Bluetooth Low Energy Mac ID, nearby Bluetooth low energy (BLE) Devices Mac ID, Service Set Identifier (SSID), hardware information of the authentication device, IMEI, operating system, operating system version, screen resolution, touch screen pattern while users was using the phone, user behavior including motion sensors information, phone number of the authentication device, whether the authentication device is jailbroken/rooted, and a like. The first and/or second encrypted message may also include a Time and Location based One Time Password (LTOTP). The LTOTP is a one-time password randomly generated based on location information that is received from the authentication device 20 GPS, WiFi, cell tower information, and the like.

At 345, the browsing device 10 receives two messages. The browsing device 10 only decrypts the encrypted first message that is designed to be decrypted by the browsing device 10 and includes the authentication result. At 347, if the authentication result is negative, then the process proceeds to 337, the browsing device 10 notifies the authentication server 30 of unusual activities. This flags the account and/or the username as being at risk which may result in limiting access to the account, webpage, application, software, and the like or temporary or permanently suspending any actions that needs users' authentication or authorization.

If the authentication result is positive, then the process proceeds to 349 and the browsing device 10 creates another encrypted message including one or more of: the type of device, device name, Mac ID, session information (i.e. hardware information, browser name, browser version, operating system, operating system version, IP address, agent operating system, browser size, hardware information), session ID and the like. The browsing device 10 sends both messages—the second encrypted messaged created by the authentication device 20 that includes the LTOTP and other information about the authentication device 20, and the message created by the browsing device 10 that includes the browsing device's session information—to the authentication server 30.

At 319, the authentication server 30 receives both encrypted messages. The authentication server 30 first checks the challenge signed by the authentication device using its public key, and then the authentications server 30 decrypts both encrypted messages. At 321, the authentication server 30 determines if the received LTOTP is correct. If the signed challenge or one time password is not correct, then the process moves to 337 and the authentication server 30 flags the account and/or the username as being at risk which may result in limiting access to the account, webpage, application, software, and the like or temporary or permanently suspending any actions that needs user's authentication or authorization.

At 323, if the signed challenge matches what that authentication server 30 expects and one time password is correct, the server checks the browsing device 10 information with information received from the authentication device 20. If the information received from the authentication device 20 and the information received from the browsing device 10 message don't match, then the process proceeds to 337 and the server flags the account and/or the username as being at risk which may result in limiting access to the account, webpage, application, software, and the like or temporary or permanently suspending any actions that needs user's authentication or authorization.

At 325, if the information received from both the authentication device 20 and the browsing device 10 match, the authentication server compares received information with previous received device information corresponding to the devices. This is done as another layer of security. Comparing device and session information from the current session with device and session information receive in previous session(s) enables the authentication to detect any unusual activities. This is executed by running a fraud-detection machine-learning algorithm on the authentication server 30.

If the machine-learning algorithm detects any unusual activity or the time and location of a previous session varies significantly from the current session, the authentication server 30 flags the account and/or the username as being at risk which may result in limiting access to the account, webpage, application, software, and the like or temporary or permanently suspending any actions that needs user's authentication or authorization.

If the machine-learning algorithm doesn't detect any unusual activity or the session and devices information of previous session doesn't vary significantly from the session and device information of current session, then the process moves to 327 and the authentication process is completed and the user authentication or authorization is successfully completed, for example, the user is granted access to an application or account.

Using the Location and Time Based One Time Password (LTOTP) first enables the system to generate a password that changes every time based on the location and time of the session. This secures the authentication method against a variety of attacks such as a man-in-the-middle attack. In addition, process 300 compares the location information (which may include GPS information, WiFi information, cell tower information, radio signal signature, and a like) of the authentication device 20 and the browsing device 10 (which may include IP address, and the like). If these two sets of information do not match, it may indicate unusual activity.

Furthermore, checking the location and time of a previous sessions with the current session allows the authentication server 30 to detect any dramatic changes in the location. If the user request authentication or authorization at the certain point in time and a location and then later the authentication server 30 receives another request from the same user but at a location that the user could not travel to the new location since last time she/he sent the authentication request, the authentication server 30 may detect this as an unusual activity. Embodiments of the present invention also enable the authentication server 30 to automatically monitor all user's session information, location, and time in order to detect unusual activity. Embodiments of the present invention also enables the authentication server 30 to limit the access to every account to only to one session at a time. Embodiments of the present invention further enables the authentication server 30 to limit access to one account to one specific device if it is desirable.

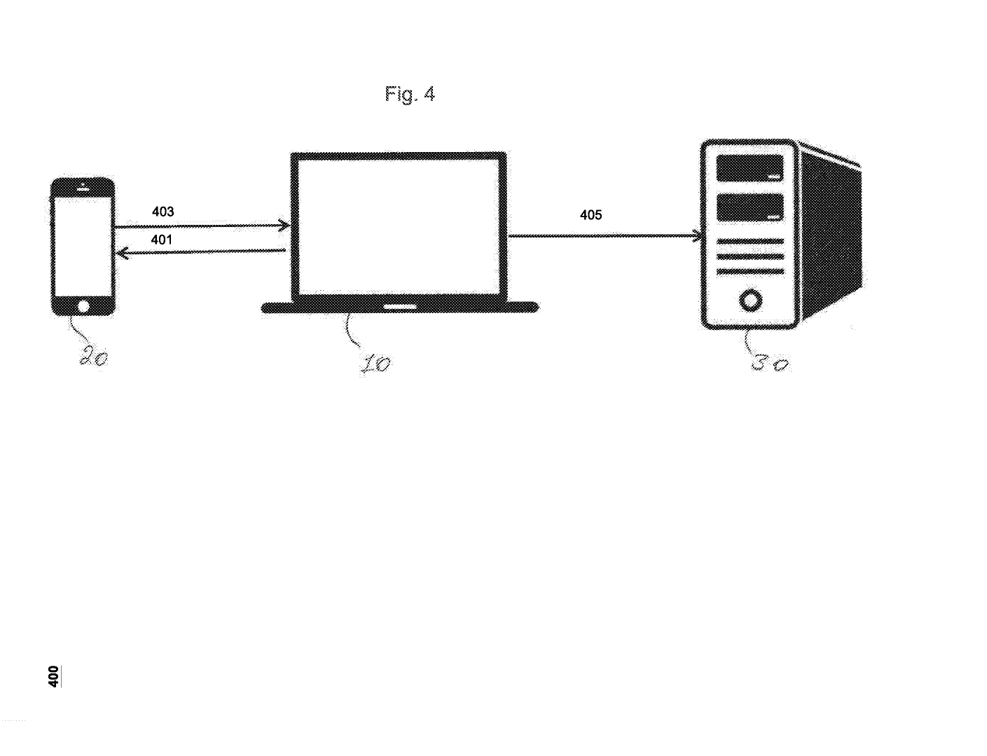

FIG. 4 shows a process 400 for communication between the browsing device 10, the authentication device 20 and the authentication server 30.

### Walkout Logout

After the user is authenticated and access to the account is granted, the browser device constantly checks if the authentication device 20 is in its proximity (items 401 and 403). This process of checking proximity varies based on the method of connection between the browsing device 10 and the authentication device 20, via any number of protocols or techniques, such as Wi-Fi, Bluetooth, cable, NFC, and the like. In one embodiment, the browser device 10, may send a ping (401) to authentication device 20 over Bluetooth, and if the authentication device 20 is in close proximity to receive the Bluetooth transmission, the authentication device 20 responds (403) to the browser device. Embodiments of the present invention thus facilitate use of applications that are desirable, for instance when the user tries to log into and log out from an account, a website, and the like.

If the browsing device 10 cannot detect the presence of authentication device 20, the authentication expires and the user's access to accounts, website, and the like is denied. For example, a message (405) may be sent from the browsing device 10 to authentication server 30 indicating the authentication device 20 is not in proximity of the browsing device.

The authentication device 20 not being in the proximity of the browsing device 10 means that the user has left the browsing device 10 taking the authentication device 20 (e.g. smartphone or smart wearable) with them. Thus, that session must be expired and the user must be logged out, as the user is not present. This method of auto-logout is more secure than auto-logout based on time. Therefore as long as auto-logout based on proximity of two device is enabled on a secured account, application or website, there is no need to use auto-logout based on time. However, it is possible to have auto-logout based on proximity of two devices (the browsing device 10 and authentication device 20) and auto-logout based on time on a system, network, account, application, or website.

### Second Embodiment

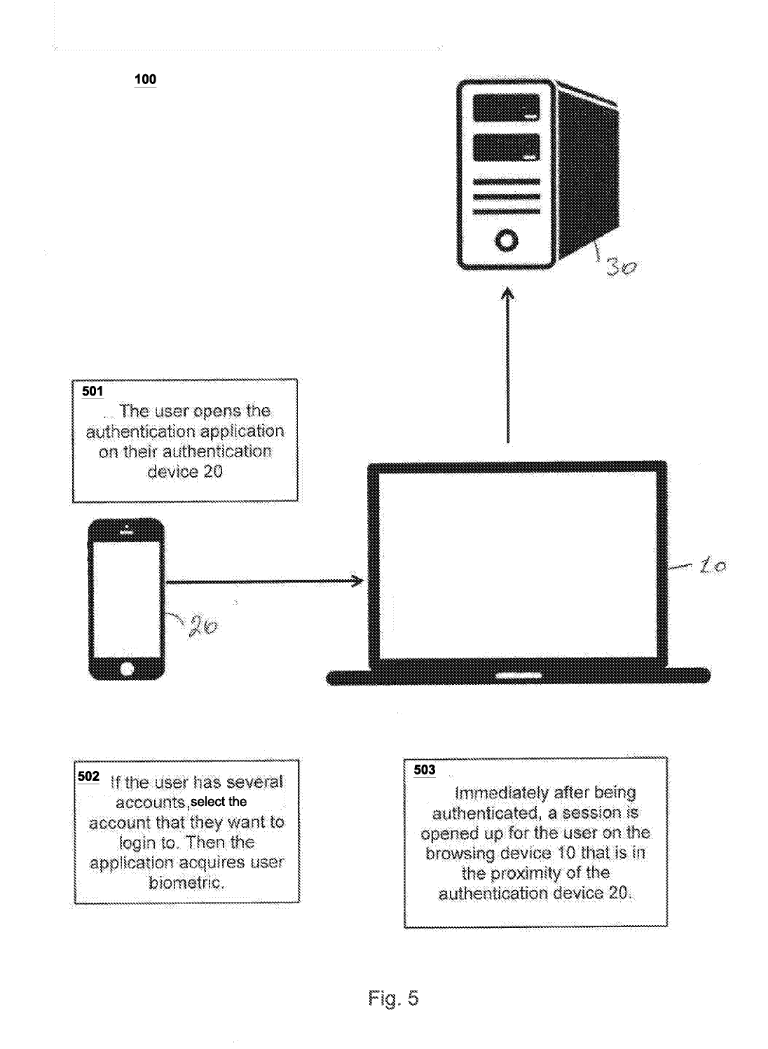

FIG. 5 illustrates a login process of system 100 according to a second embodiment of the present invention. In this embodiment, the authentication process is triggered from the authentication device 20. At 501, every time that the user needs to request to be authenticated on his/her browsing device 10, the user opens the authentication application on his/her authentication device 20 to get authenticated. At 502, if the user has several accounts associated with the authentication 20, then the user is able to select the particular account which they want to access and the application on authentication 20 acquires user biometric information. In some embodiments, different accounts may require different biometrics. For example, an e-mail account may require a voice sample and a bank account may require a fingerprint sample. At 503, once the user is locally authenticated, the browsing device 10 communicates with the authentication device 20 and the authentication process is completed once the authentication server 30 approves credentials received form the browsing device 10.

In cases that the authentication device 20 and browsing device 10 are the same, the user opens the authentication application and once authenticated, the user is directed to his/her application, account, or website.

For the authentication device 20 that the biometric reader has already been set up to unlock his/her device or perform other activities, Embodiments of the present invention can be used to check the user's biometric information. In the event that the user has not set up the biometric reader on his/her authentication device 20, during the initial setup (e.g. once the user opens the authentication application for the first time) the biometric information of the user is acquired and securely stored (i.e. encrypted and/or stored in secured memory) in the authentication device 20 for future reference. Every time a user tries to get authenticated, the authentication process based on biometric happens locally on the authentication device 20. Therefore, the biometric information of the user is not stored on the authentication server 30 and is not transferred between devices and servers.

Similar to the first embodiment, this embodiment of the present invention also includes an initial setup and an authentication process.

### Initial Setup

To set up this multi-factor authentication (MFA), the user needs to assign one device as the authentication device 20 that authentication application would be installed on and one or more devices as the browsing device 10. Based on the number of devices assigned by the user and the desirable level of security, the user may register one or more authorized browsing device 10s on his/her account.

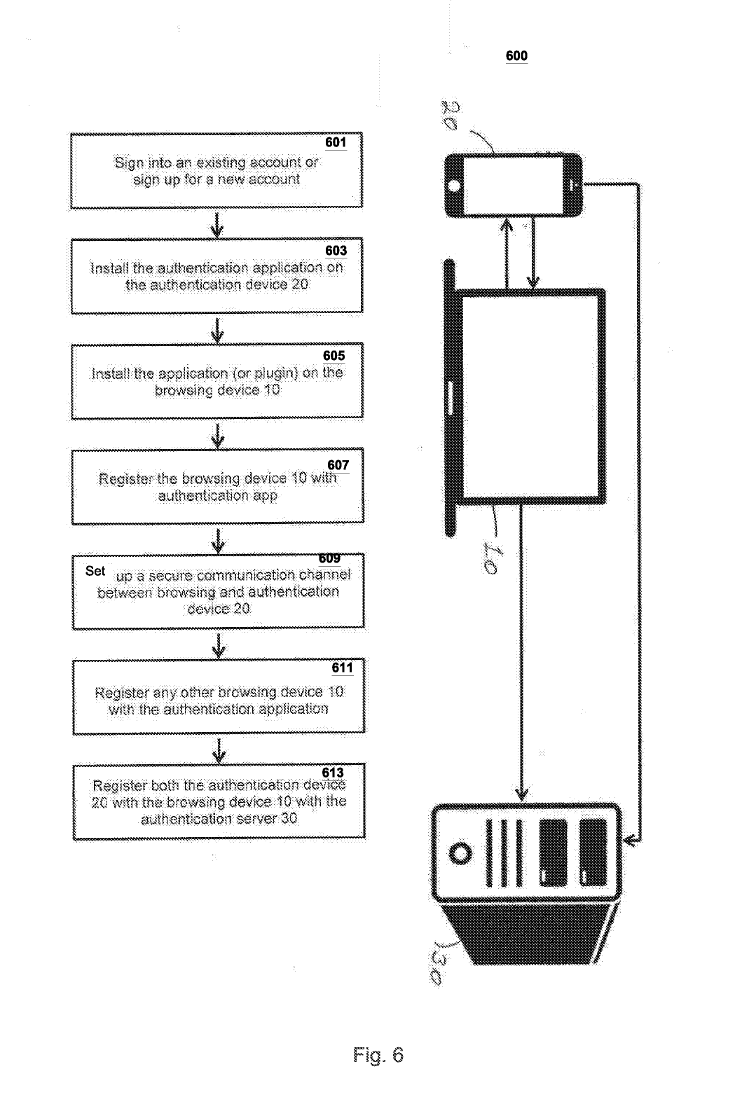

FIG. 6 shows a process 600 for registering the authentication device 20 and a browsing device 10. At 601, a user with an existing account signs into his/her accounts; new users sign up for a new account. This can be performed on the browsing device or the authentication device. For example, a user who has an existing account is authenticated on his/her browsing device(s) 10 using existing method (e.g. username and password) for the last time. In other words after entering in this existing authentication information the user will never have to enter in a password to authenticate. Instead by the end of process 600, every time the user wishes to authenticate he/she will use biometric information without manually entering in any passwords (e.g. an alphanumeric number)

The sign-up process for first time users may be similar to that used for existing users. However, the first time user may not have any account, application, or webpage to log into. To make the process more secure, the first time user may receive an email or a message on one of his/her devices—the browsing or the authentication device 20—and they may be asked to follow 603-613. This makes the sign-up process “invite only” which may be desirable to improve security.

At 603, the authentication application must be installed on the authentication device. The install may happen manually or automatically (e.g. pushed from an authentication server) Once the authentication application is opened for the first time, it acquires user biometric and once the user is locally authenticated for the first time. The authentication application registers the user's authentication device 20 (including GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while users was using the phone, user behavior including motion sensors information, phone number, whether the phone is jailbroken/rooted, and a like) with the authentication server 30 or any other server that is required. To complete this process, at 605, the user may be also required to download a software or an application (such as a plugin for the user's web browser or the user's application) on the user's browsing device 10.

At 607, the browsing device which the user wishes to use must be registered with the authentication application of the authentication device. To complete this setup, the software or application installed on the browsing device communicates with the authentication device to send its device information (e.g. the type of device, device name, Mac ID, hardware information, browser name, browser version, operating system, operating system version, IP address, agent operating system, browser size, hardware information, session ID and the like) in an encrypted message. At 609, once the user is authenticated via existing authentication method for the existing users—or once the user start the sign-up process for the new users—, the authentication application is installed and the browsing device is registered with the authentication application a secure line of communication between the browsing device 10 and the authentication device 20 must be set up for the first time. The secure communication channel may be established by creating a pair of public and private key generation and storing the private key on the authentication device 20 and the public key on the browsing device 10. The browsing device and the authentication device may then communicate with each other securely via asymmetric cryptography. 609 can be executed manually or triggered automatically (for instance, by scanning a barcode—such as QR code that is shown on the screen of the browsing device 10—using the authentication device 20). This secured line of communication channel may be via any number of protocols or techniques, such as Wi-Fi, Bluetooth, Ad-hoc, Near Field Communication, cable, and the like. This process can be executed manually or semi-manually (for instance, in which the user download the authentication application and then scanning a barcode that sets up the communication between two devices). Another example is that one of the devices (either the authentication device 20 or the browsing device 10) creates a local network and another device tries to search for that network and connect to it.

At 611, after setting up the first browsing device 10 and the authentication device 20, if it is desirable for the user to use more than one browsing device 10 to be authenticated on, the user may be required to download special software or the application that must be installed on the browsing device 10 on other browsing devices. Then the user will go through the process of registering extra browsing devices the authentication device 20 as detailed in 607.

If the user is using a browsing device 10 that loads its programs from a server, the process of uploading and installing required software on the browsing device 10 is done on the server that the browsing device 10 upload its software from. Then every time that the browsing device 10 uploads relevant software from the server, this piece of software is also uploaded and ready for authentication.

At 613, the authentication device and the one or more associated browsing devices are registered with the authentication server 30. To do that, the authentication device creates another set of public key and private key, and sends the public key along with device information about the authentication device—including: GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while users was using the phone, user behavior including motion sensors information, phone number, whether the phone is jailbroken/rooted, and a like—to the authentication server. Once the authentication device 20 register its information with the authentication server 30, the initial registration process is completes. In the same message, the authentication device also includes all information received from the browsing devices registered at steps 607 to 611, which registers authorized browsing devices with the authentication server.

At the conclusion of 613, whenever the user authenticates, he/she will no longer authenticate using their old authentication method (as described in step 601). Instead the user will provide their biometric information to be authenticated locally to the authentication device.

### Authentication Process

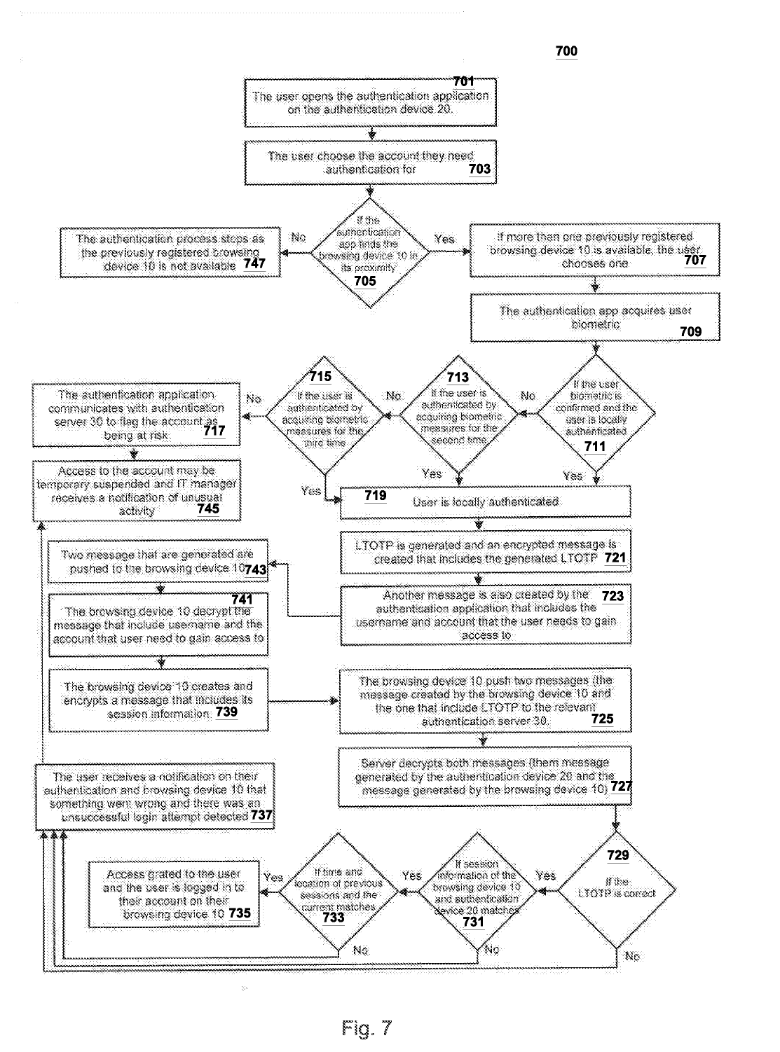

FIG. 7 illustrates process 700 according to the second embodiment for user authentication (e.g. when the user needs to login to his/her account) after the initial set up has been completed. As described above, the browsing device 10 and the authentication device 20 are assumed to have been already paired and a secured communication channel is assumed to have been set up between them. In this embodiment, the user may have more than one accounts, websites, accounts, cloud services, Virtual Private Networks (VPNs), and the like, that require authentication. In addition, the user may use one or more browsing device(s) 10 authorized for gaining access to accounts, websites, accounts, cloud services, VPNs, and the like.

At 701, every time that user wants to request user authentication or 20 authorization, the process starts by the user opening the authentication application on his/her authentication device 20. At 703, once the user opens the authentication application on his/her device, if they have registered several accounts, websites, cloud services, VPNs, application, and the like, on the authentication device 20, then the user selects the account that the user need authentication for.

At 705, the authentication application determines if a registered browsing device is in proximity. If the user has multiple registered browsing devices the user is chooses the browsing device 10 that they want to be authenticated on. The authentication application can also scan to see which one of the browsing devices is in its proximity and then the user can choose the desired one. This scanning process varies based on the type of communication channel previously setup between two device. For example, the scanning process could be searching Bluetooth signal, creating and search for local network, creating or search for ad-hoc network, researching the WiFi network to see what other devices are connected to the same network, or asking the user to put two devices (the browsing and the authentication devices) close to each other to user Near Field Communication, or via other protocols or techniques.

If the user only registered—or is limited to—one browsing device, the authentication application then scans to see if the browsing device 10 is in the proximity. If the authentication application cannot find a previously registered browsing device that is in the proximity, then the process moves to 747 and the authentication process stops.

At 707, if one or more previously registered browsing devices are in the proximity of 10 the authentication device 20, the authentication application allows user to choose which one is preferred.

At 709, once a browsing device is chosen, the authentication application acquires user biometric information. No matter if the authentication device 20 has a screen lock activated that asks for biometric to unlock the screen or not, once the user reaches this, the authentication application acquires user biometric. Based on the operating system and hardware available on authentication device 20, the authentication application may acquire various forms of biometric information such as fingerprint, voice, face image, finger geometry, heart ECG biometric, vein patterns, Iris pattern, and the like; that is available on the device.

At step 711, if the user local authentication process via checking biometric fails the first time, the user may be given more chances (i.e. 713-715). Based on the desired level of security, IT administration may be able to set the attempts for local authentication using biometric information. In process 700, this number is set to be three times. The second and third authentication attempts are shown in 713 and 715 respectively.

After three times (or the desired number of times), at 717, if the user is not authenticated locally on the authentication device based biometric information, the authentication device 20 communicates—either directly or through the browsing device 10—with the authentication server 30 to flag the account and/or the username as being at risk and the process moves to 745, which may result in limiting access to the account, webpage, application, software, and the like or—temporary or permanently—suspending any actions that needs user's authentication or authorization.

If the local user authentication process via checking biometric information is completed successfully, the authentication device 20 creates two encrypted messages. At 721, the first message is for the authentication server 30. This encrypted message also includes a signed message signed by the authentication device's 20 private key and other device information such as GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while users was using the authentication device, user behavior including motion sensors information, phone number of the authentication device, whether the authentication device is jailbroken/rooted, and a like, and a Time and Location based One Time Password (LTOTP). The second is for the browsing device. This second encrypted message may also include the username and account, website, application, VPN or couple service that the user requires authentication for. These two messages are pushed to the browsing device 10

An alternative architecture to sending two messages to the browsing device 10 is that the authentication device 20 sends the message that includes LTOTP directly to the authentication server 30. Even in this case, the authentication device 20 sends a message that includes a username and an account that the user is seeking to gain access to, to the browsing device 10. This can be done to improve the security of this process by separating communication between the browsing device 10 with authentication server from communication between the authentication device 20 with the authentication server.

At 743, once the browsing device 10 receives two messages (or in some case one message if the authentication device 20 is set to communicate directly with the authentication server), at 741, the browsing device 10 decrypts the message that includes the username and the account that the user tries to gain access to. The browsing device is only able to decrypt this message due to the cryptographic properties of the second message (i.e. the second message is signed with the browsing devices public key, so only the browsing device's private key may decrypt the message.) At 739, the browsing device 10 creates another encrypted message that includes one or more of the following forms of device information: its type of device, device name, Mac ID, hardware information, browser name, browser version, operating system, operating system version, IP, agent operating system, browser size, hardware information, session information and a like and at 725, sends the another encrypted message to the authentication server 30, along with the encrypted message received from the authentication device 20 that was meant for authentication server 30 (which has not been decrypted by the browsing device 10). Alternatively, if the authentication device 20 is set to communicate directly with the authentication server 30, the browsing device 10 will only have one message (the message that it creates and includes one or more forms of additional information (its session and/or device information)) to the authentication server 30. The cryptographic properties of respective encrypted messages allows the messages to be decrypted by only the intended recipients. The cryptographic properties will vary according to the cryptographic techniques utilized. For example, in an embodiment using asymmetric cryptography, messages intended for the authentication server will be encrypted by the authentication server's public key, so only the authentication server's private key can be used to decrypt the message.

At 727, the authentication server decrypts two messages that it receives from the browsing device 10. Alternatively, if the authentication device 20 is set to communicate directly with the authentication server 30, the server decrypts two messages, one received from the browsing device 10 and another received from the authentication device 20. It should be highlighted no matter how the authentication device 20 communicates with the authentication server 30—either directly or through the browsing device 10—the message that is generated by the authentication device 20 for the authentication server 30 and it includes the location and time base one time password (LTOTP) is only accessible by the authentication server 30. Therefore, even if the communication between the authentication device 20 and the authentication server 30 is set up to go through the browsing device 10, the browsing device 10 does not decrypt and gain access to the message that includes LTOTP.

Once the authentication server 30 decrypts the two received messages—one originally created by the authentication device 20 and the other one originally created by the browsing device 10—at 729, the authentication server 30 first checks the signed challenge by the authentication device 20 private key with its public key and the LTOTP. If the received LTOPT does not matches the LTOTP that an algorithm running on the authentication server creates based on the location of the authentication device 20 or the signed message by the private key doesn't match the signed message by the public key, then the process proceeds to 737 and 745 and the authentication server 30 flags the account and/or the username as being at risk which may result in limiting access to the account, webpage, application, software, and the like or—temporary or permanently—suspending any actions that needs users' authentication or authorization. The user also receives a notification on the browsing device 10 and the authentication device 20 that his/her account is flagged as being at risk.

At 731, if the LTOTP is what the authentication server expected and matches the one generated by the algorithm run on the authentication server 30, the authentication server compares the device information received from the authentication device 20 message and/or the browsing device 10 information included in his/her respective encrypted messages—including one or more of the following: type of device, device name, Mac ID, hardware information, browser name, browser version, operating system, operating system version, IP, agent operating system, browser size, hardware information, session information and a like—with information received from the respective device. If those two sets of information do not match, then the process proceeds to 737 and 745 and the authentication server detects another risk to the account. This flags the account and/or the username as being at risk which may result in limiting access to the account, webpage, application, software, and the like or—temporary or permanently—suspending any actions that needs users' authentication or authorization.

At 733, if the information received from the browsing device 10 and the device information received from the authentication device 20 match, then the authentication server 30 checks details of the current session—including one or more of the following: GPS information, location information of WiFi, cell tower info that the authentication device communicates with, latent signals, Mac ID, WiFi Mac ID, WiFi Network SSID, Bluetooth Low Energy Mac ID, nearby BLE Devices Mac ID, SSID, hardware information of the authentication device, IMEI, operating system, operating system version, screen resolution, touch screen pattern while users was using the phone, user behavior including motion sensors information, phone number, whether the authentication device is jailbroken/rooted, and a like—with details of previous sessions. If the information from current session is not dramatically different from the previous session, at 735, the authentication server 30 authorizes and/or authenticates the user. This may result in processing user's request for the authentication or authorization. For example, the user is granted access and/or get logs in to his/her account, website, application, cloud server, VPN, and the like.

Comparing details of the current session—such as location and time—with details of the previous sessions enables the authentication to detect any unusual activities. This is executed by running a fraud-detection machine-learning algorithm on the authentication server 30.

If the machine-learning algorithm detects any unusual activity or the time and location previous session varies significantly from current session, then the process proceeds to 737 and 745 and the authentication server 30 flags the account and/or the username as being at risk which may result in limiting access to the account, webpage, application, software, and the like or—temporary or permanently—suspending any actions that needs user's authentication or authorization.

Using the LTOTP enables the system to be able to generate password that varies every time based on the location and time of session. This secures the authentication method against variety of attacks such as the-man-in-the- middle. In addition, this method compares the location information (that includes GPS Information, WiFi information, and Cell Tower information) of the authentication device 20 and/or the browsing device 10 (that includes IP address, WiFi information and the like). If these two sets of information do not match, it may it indicate unusual activity.

In addition, checking the location and time of the previous sessions with the current session allows the system to detect any dramatic changes in the location. If the user request for authentication or authorization at the certain point at time and a location and then later the authentication server 30 receives another request from the same user but at a location that the user could not travel to since last time the user sent the authentication request, it may indicate unusual activity. Furthermore, embodiments of the present invention also enables the authentication server 30 to automatically monitor all user's session information, location and time in order to detect unusual activity Also, embodiments of the present invention also enables the authentication server 30 to limit access to every account only to one session at a time. In addition, embodiments of the present invention enables the authentication server 30 to limit access to one account to one certain device as the authentication device 20 and one certain device as the browsing device 10.

### Walkout Logout

Once the user is in the process of being authenticated, the browser device constantly checks its proximity looking for the authentication device 20. This process of checking proximity varies based on the method of connection between the browsing device 10 and authentication device 20, via different protocols or techniques. For example, if the communication between two devices is over Bluetooth, the proximity may be checked by sending a beacon of Bluetooth every often; In another example, if the connection between two devices is over Wi-Fi, the proximity is checked based on two devices being connected to a same network.

As soon as, the browsing device 10 cannot detect the presence of authentication device 20 or the authentication device cannot detect the presence of the browsing device 10, the user session expires and the user is no longer authenticated. For example, if the user is logged into an account, a webpage, or the like, they will be logged out if proximity is not detected. The authentication device 20 not being in the proximity of the browsing device 10 means that the user has left the browsing device 10 taking the authentication device 20 with them. Thus, the user's session may expire.

This method of auto-logout is more secure than auto-logout based on time. It is possible and recommended that both auto-logout based on proximity and auto-logout based on time are enabled in order to improve security of the system, network, account, application, website, could service, VPN, and the like.

Since the user starts the authentication process on the authentication device 20, it is convenient for the user to be able to logout from his/her account, application, network, account, application, website, could service, VPN, and the like—that is secured by invention—from his/her authentication device 20. On most accounts, applications, networks, accounts, applications, websites, could services, VPNs, and the like, the user has a button to select to logout on his/her browsing device 10. Adding this button on the authentication application on the authentication device 20 not only is a convenient for the user but also improves security. This feature may be added to other embodiments if it is desirable.

### Third Embodiment

In this embodiment the authentication process is triggered from the browsing device. The user—on his/her browsing device—requests to be authenticated. For example, the user opens an application, a website, login page of network, could service, VPN, and the like and selects a login or sign-in button.

Once the user requests user authentication or authorization, the user receives a notification on his/her previously registered authentication device 20. Then, the user opens the authentication application on the authentication device 20. This process may be facilitated by just opening the notification on the authentication device 20 and the notification directs the user to the authentication application. Once the authentication application is opened the application acquires user's biometric information; such as fingerprint, voice, face image, finger geometry, heart ECG biometric, vein patterns, Iris pattern, and the like.

If the user's biometric information matches the record, the authentication device 20 communicates with the authentication server 30 and the user is granted access. This embodiment is similar to the first embodiment as described with reference to FIG. 1. However, a significant difference between this embodiment and the first one is that the authentication device 20 and the browsing device 10 do not directly communicate with each other. Instead, in this embodiment, the browsing device 10 and the authentication device 20 directly communicate with the authentication server 30.

For the authentication device 20 that a biometric reader has already been set up to unlock his/her device or perform other activities, embodiments of the present invention may use this existing setup to check user biometric information. In the case that the user has not set up the biometric reader on his/her authentication device 20, in the initial setup—once the user opens the authentication application for the first time—the biometric information of the user is acquired and securely stored (i.e. encrypted and/or stored in secured memory of the authentication device) in the authentication device 20 for future reference. Every time a user attempts to be authenticated, the authentication process based on biometric information happens locally on the authentication device 20. Therefore, biometric information of the user is not stored on the authentication server 30 and is not transferred between devices and servers.

As described in relation to previous embodiments, execution of this embodiment includes two steps: an initial setup and an authentication process.

### Initial Setup

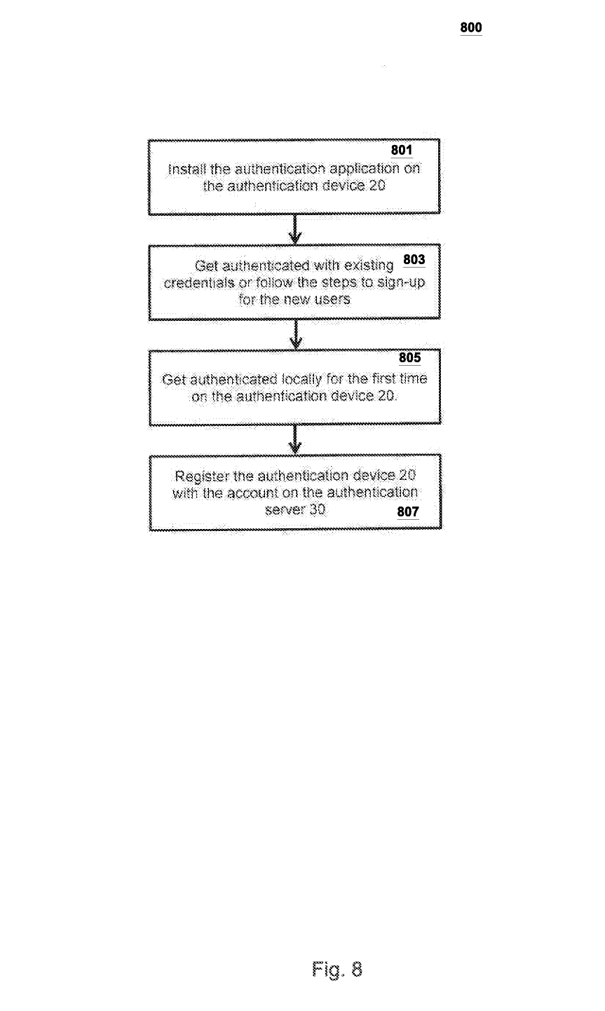

FIG. 8 illustrates process 800 for the initial set up according to a third embodiment of the invention. The initial setup for this embodiment is relatively simple since the authentication device 20 and the browsing device 10 do not need to communicate directly.

Therefore, to set up this multi-factor authentication (MFA), at 801, the user first assigns a device as the authentication device 20 and the user downloads the authentication application on his/her authentication device 20. Next at 803, the user only needs to register the authentication device 20 with his/her account.

If the user is an existing user, the user logs into the account, application, webpage, and the like, on the authentication device 20 or a browsing device 10 using the existing solution (e.g. username and password) for the last time. In other words after entering in this existing authentication information the user will never have to enter in a password to authenticate. Instead by the end of process 600, every time the user wishes to authenticate he/she will use biometric information without manually entering in any passwords (e.g. an alphanumeric number).

If the user is a new user who does not have an account prior to implementation of embodiments of the present invention, the user follows a sign-up process. The sign-up process for first time users may be similar to the existing user. Since the first time users may not have an account, application, or webpage to log into, they may receive an email or a message on one of his/her devices (i.e. browsing device or authentication device). This makes the sign-up process “invite only” which may be desirable to improve security.

Once the user is authenticated by the existing credential, following the link sent to the user via a message or an email, or entering a one-time password, and the like, the user's authentication device 20 is registered with his/her account. This process may be done manually by entering the authentication device 20 information. Alternatively, this process can be done automatically by scanning a code, barcode, square barcode, or a picture that is presented on the browsing device 10 using the authentication application on the authentication device 20. The account information is securely transferred to the authentication application and would be encrypted and secured on the authentication device 20. At 805, the authentication application acquires user biometric information to authenticate the user locally for the first time. Next at step 807, once the user is locally authenticated for the first time, the authentication application communicates directly with the authentication server 30 to register the authentication device 20 with the user's account. To do this initial registration, the authentication device 20 creates a pair of public key and private key and send the public key along with addition information—including GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while users was using the phone, user behavior including motion sensors information, phone number, whether the phone is jailbroken/rooted, and a like—to the authentication server 30. This completes the initial setup for the third embodiment. Once the initial setup process is completed and the user logs out from his/her account, this authentication process can be executed in order to login to the authentication application.

As the browsing device 10 and the authentication device 20 do not need to communicate directly, the browsing device 10 does not need to download extra software, application, plugin, and the like, as may have been required in the first and second embodiments This embodiment of the present invention also allows the user to login to his/her account, website, application, could service, VPN, and the like, from different browsing devices. The number of browsing devices can be unlimited or limited by the IT administration based on desirable level of security.

At the conclusion of 807, whenever the user authenticates, he/she will no longer authenticate using their old authentication method (as described in step 801). Instead the user will provide their biometric information to be authenticated locally to the authentication device.

### Authentication Process

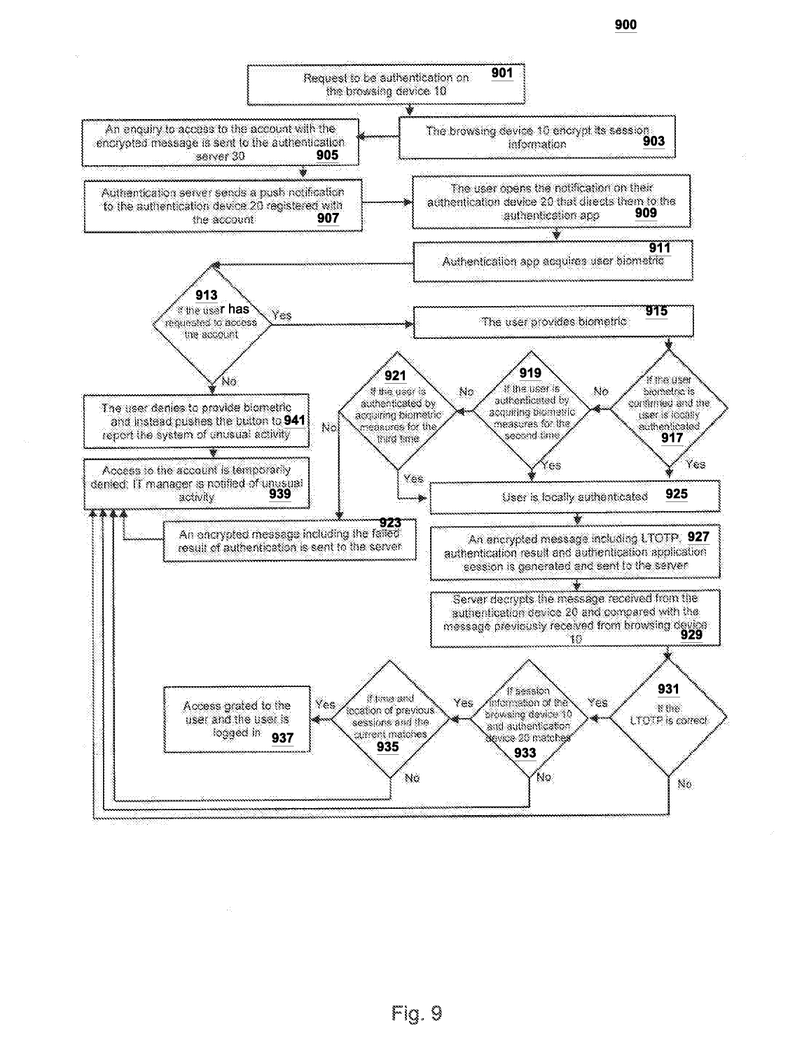

FIG. 9 shows authentication process 900 after the initial setup and user's authentication device registration is completed. As previously mentioned, in this embodiment, there is no need to pair the browsing device 10 and the authentication device 20 since they do not directly communicate.

At 901, the user requests user authentication or authorization. Next at 903, the browsing device 10 encrypts its session information and other device information (such as type of device, device name, Mac ID, hardware information, browser name, browser version, operating system, operating system version, IP, agent operating system, browser size, hardware information, session information and a like) and at 905, the browsing device sends the encrypted message with an enquiry to authenticate the user to the authentication server 30, either directly or through the relevant server. The relevant server can be client web server, cloud server, and a like through which the user is trying to gain access to his/her account.

Once the authentication server 30 gets the inquiry for the browsing device 10, it decrypts the received message and matches the user information with his/her account. At 907, the authentication server sends a push notification to the authentication device 20 of that specific user that is registered with the account. In addition to the push notification that is designed to alert the user, the authentication server also sends an encrypted message to the user's authentication device to request authentication. This message also includes a challenge that needs to be signed by the authentication device 20. At 909, once the user gets the notification on his/her authentication device 20, the user opens the authentication application or opens up the notification that directs the user to the authentication application. Upon opening the application, the authentication application 20 also receives the encrypted message and the challenge from the authentication server. Then at 911, the authentication application on the authentication device acquires the user biometric information that could be fingerprint, voice, face image, finger geometry, heart ECG biometric, vein patterns, Iris pattern, and the like.

No matter if the authentication device 20 has a screen lock activated that asks for biometric to unlock the screen or not, once the user opens the authentication application, the authentication application acquires user biometric information. Based on the operating system and hardware available on authentication device 20, the authentication application may acquire different type of biometric information, such as fingerprint, voice, face image, finger geometry, heart ECG biometric, vein patterns, Iris pattern, and the like.

At 913, it is determined if the user expected/requested the previously sent notification. At 941, if the user did not expect the notification and the user has not requested to be authenticated but received a notification, the user can deny providing biometric information. This results in authentication process is being failed. At 939, the user then may push the alert button on the application, reporting that they did not request to be authenticated. This flags the account and/or the username as being at risk which may result in limiting access to the account, webpage, application, software, and the like, or—temporary or permanently—suspending any actions that needs user's authentication or authorization.

Alternatively, if the user has requested the access, the user continues the authentication process (915) by providing biometric information. At 917, it is determined if the provided biometric information matches stored biometric information. If not then the user may be given more chances to authentication (i.e. 919-921). Based on the desired level of security, IT administration may set the number of time that a user can try to get locally authenticated through getting biometric information. In process 900, this number is set to be three times. Therefore the user is only able to provide its biometric information two more times if the first attempt fails.

After previously set number of times (for instance, three as is shown in the FIG. 9), if the user is not locally authenticated on the authentication device 20 based on his/her biometric information, then at 923, the authentication device 20 sends negative results to the authentication server 30. This flags the account and/or the username as being at risk which may result in limiting access to the account, webpage, application, software, and the like or—temporary or permanently—suspending any actions that needs users' authentication or authorization.

If the user local authentication process via checking biometric is completed successfully, then at 925, the user is locally authenticated. Next at 927, the authentication device 20 signs the challenge received from the authentication server with its private key.

Then the authentication device generates an encrypted message including a LTOTP and other device and session information—such as including GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while the user was using the authentication device, user behavior including motion sensors information, authentication device phone number, whether the authentication device is jailbroken/rooted, and the like and sends it to the authentication server 30.

At 929, the authentication server 30 decrypts the received message from the authentication device 20. Then, at 931, the authentication server 30 first checks the signed challenged by the authentication device 20 private key with the authentication device's public key. The authentication server also checks the LTOTP. If any of the above elements do not matches what the authentication server 30 expects, then the process proceeds to 939 and the authentication server 30 flags the account and/or the username as being at risk which may result in limiting access to the account, webpage, application, software, and the like or—temporary or permanently—suspending any actions that needs user's authentication or authorization. The user also receives a notification on the browsing device 10 and the authentication device 20 that his/her account is flagged as being at risk.

LTOTP enables the system to generate a password that varies every time based on the location and time of the session. This secures the authentication method against variety of attacks such as the-man-in-the-middle. In addition, this method compares the location information (that includes GPS, WiFi information, information of cell tower that the authentication device communicates with) of the authentication device 20 and the browsing device 10 (that includes IP address, and the like). If these two sets of information do not match, it may indicate unusual activity.

If the LTOTP is what the server expects by matching the LTOTP generated by the algorithm run on the authentication server 30, then at 933, the authentication server compares the browsing device 10 information—including its session information and location—received earlier from the browsing device 10 with information received from the authentication device 20.

The server compares the browsing device 10 information—for example, its session information, location, and the like—with information received from the authentication device 20. If those two sets of information do not match, the server detects another risk to the account, and the process proceeds to 939 and the account and/or the username are flagged as being at risk which may result in limiting access to the account, webpage, application, software, and the like or—temporary or permanently—suspending any actions that needs user's authentication or authorization.

If the information received from the browsing device 10 and the information received from the authentication device 20 match, then at 935, the authentication server 30 checks details of other information received from the authentication device—such as GPS information, location information of WiFi, cell tower info that the smartphone communicates with, latent signals, Mac ID, WiFi Mac ID, WiFi Network SSID, Bluetooth Low Energy Mac ID, nearby BLE Devices Mac ID, SSID, hardware information of the authentication device, IMEI, operating system, operating system version, screen resolution, touch screen pattern while users was using the authentication device, user behavior including motion sensors information, phone number of the authentication device, whether the authentication device is jailbroken/rooted, and a like—from the current session with the same information received from previous sessions. Comparing details of the current session with details of the previous sessions enables the authentication sever to detect any unusual activities. This is executed by running a fraud-detection machine-learning algorithm on the authentication server 30.

At 935, if the information from current session is not dramatically different from the previous session, then the process proceeds to 937 and the authentication server 30 authorizes and/or authenticates the user. This successfully completes the authentication process. For instance, the user is granted access and/or gets logged in to his/her account, website, application, cloud server, VPN, and the like.

If the machine-learning algorithm detects any unusual activity or the information received from the authentication device in the current session varies significantly from previous sessions, then the process proceeds to 939 and the authentication server 30 flags the account and/or the username as being at risk which may result in limiting access to the account, webpage, application, software, and the like or—temporary or permanently—suspending any actions that needs user's authentication or authorization.

The authentication program that is run on the authentication server 30 is able to limit the user to be authenticated only from certain geographic areas and/or certain times. The authentication program of the authentication server is also able to exclude certain geographic areas and/or certain times, so any authentication requests from those areas are not authorized and flag the associated account as being at risk.

Besides checking the location and time of the previous sessions with the current session allows the authentication server 30 can detect any dramatic changes in the location. For example, if the user requests for authentication or authorization at a certain time and then the authentication server 30 receives another request from the same user but at a location that the user could not traveled to since the last time the user sent the authentication request, the authentication server 30 could indicate this as an unusual activity. Embodiments of the present invention also enables the authentication server 30 to automatically monitor all user's session information, location and time in order to detect unusual activity or session. Embodiments of the present invention also enables the authentication server 30 to limit access to every account only to one session at a time. Embodiments of the present invention enables the authentication server 30 to limit access to one account to one certain device as the authentication device 20 and one certain device as the browsing device 10.

### Logout Option

Since the authentication device 20 and the browsing device 10 do not communicate directly, the walkout logout option provided in previous embodiments would be not available in this third embodiment of the invention. However if this option is desirable, a local communication—as provided in previous embodiments—can be set up only for logging the user out when the user walk away from the browsing device carrying the authentication device 20 with them.

Other solution for having this option would be to constantly monitor the authentication device 20 GPS data or motion sensors. This may be done on the authentication device 20 or the information can be transferred to the authentication server 30 for monitoring the location of the authentication device 20. Then if the GPS information or motion sensors information show that the authentication device 20 is moved away from the browsing device 10, the user will automatically be logged out.

If the walked-out logout option is not activated, an embodiment of the invention, provides a logout button on the authentication application that is installed on the authentication device 20. The user would be able to end the session that has been authenticated for by selecting the logout button on the authentication device 20. Thus, if the user walks away from his/her browsing device 10 before logging out of the account, application, network, account, application, website, could service, VPN, and the like, the user would be able to log out by pressing or clicking a button on his/her authentication device 20.

### Fourth Embodiment

In the fourth embodiment, the authentication process is triggered from the authentication device 20. Therefore, every time the user needs to be authenticated or authorize an online activity—such as log into his/her application, account, website, network, could service, VPN, and the like—the user initiates the process by opening the authentication application on the authentication device 20. This embodiment is similar to the second embodiment, once the user is locally authenticated on the authentication device 20, the authentication device 20 communicates with the authentication server 30 to grant access to the user on the browsing device 10. It is possible to use one device as both the authentication device 20 and the browsing device 10. In such cases, the user opens the authentication application and once the user is authenticated, the user would be authorized to proceed with the action that they needed the authentication for (e.g. directed to the application, account, website, and the like, if the user was trying to log into an application, account, website, and the like).

For the authentication device 20 that biometric reader has already been set up to unlock his/her device or perform other activities, an embodiment of the present invention uses the existing setup to check user biometric information. In case that the user has not set up the biometric reader on his/her authentication device 20, in the initial setup—once the user opens the authentication application for the first time—biometric information of the user is acquired and securely stored (i.e. encrypted and/or stored in secured memory of the authentication device) for the future reference. Every time a user attempts to get authenticated, the authentication process based on biometric information happens locally on the authentication device 20. Therefore, the biometric information of the user is not stored on the authentication server 30 and is not transferred between devices and servers.

Similar to the first embodiment, this embodiment of the present invention also includes two steps: an initial setup and an authentication process.

### Initial Setup

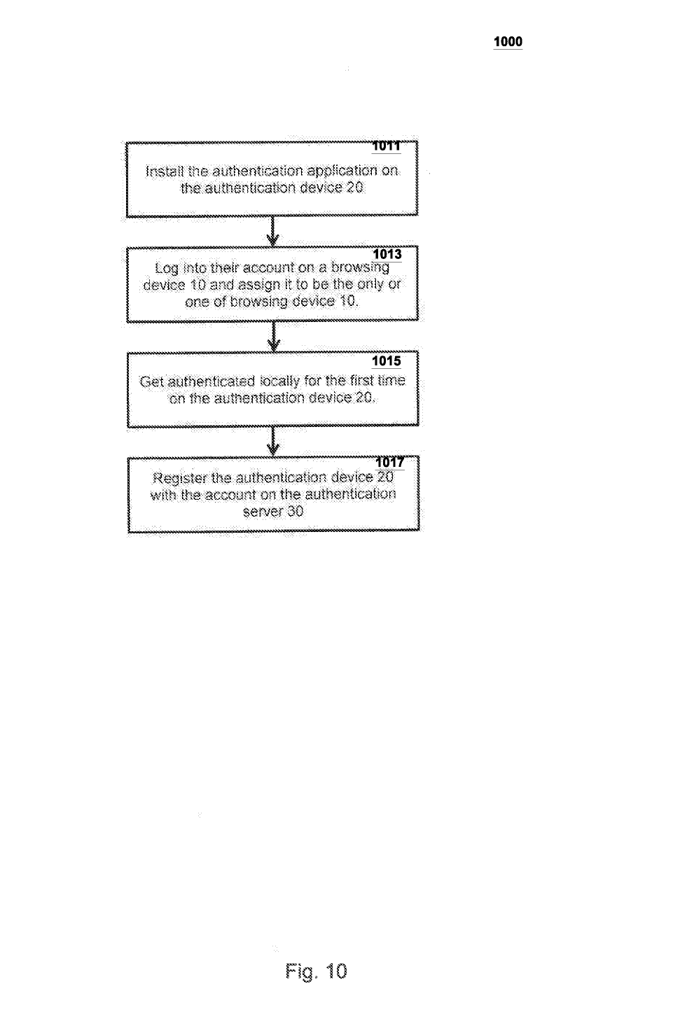

FIG. 10 shows process 1000 for completing the initial setup. The initial setup for this embodiment is simple and similar to the previous embodiments. The authentication device 20 and the browsing device 10 do not need to communicate directly. Therefore, to set up this multi-factor authentication (MFA), the user first needs to assign a device as the authentication device 20. At 1011, the user downloads the authentication application on the authentication device 20. Next at 1013, the user logs into his/her account on the browsing device.

In order to do that, if the user is an existing user, s/he gets authenticated using an existing solution—e.g. logs into the account, application, webpage, and the like, on the authentication device 20 or a browsing device 10 using the existing solution (e.g. username and password)—for the last time. In other words after entering in this existing authentication information the user will never have to enter in a password to authenticate. Instead by the end of process 600, every time the user wishes to authenticate he/she will use biometric information without manually entering in any passwords (e.g. an alphanumeric number).

If the user is a new user who does not have an account prior to implementation of an embodiment of the invention, the user follows a sign-up process. The sign-up process for first time users may be similar to an existing user. Since the first time users may not have any account, application, or webpage to log into, they may receive an email or a message on one of his/her devices (e.g. the browsing device 10 or the authentication device 20). This makes the sign-up process “invite only” which may be desirable to improve security.

Once the user is authenticated by existing credentials, following the link sent to the user via a message or an email, or entering a one-time password, and the like, the user's authentication device 20 is registered with his/her account. This process may be done manually by entering the authentication device 20 information. Alternatively, this process can be done automatically by scanning a code, barcode, square barcode, or a picture that is presented on the browsing device 10 using the authentication application on the authentication device 20. The account information is securely transferred to the authentication application and would be encrypted and secured on the authentication device 20.

At 1015, the user gets locally authenticated via acquired biometric information. At 1017, once the user is locally authenticated for the first time, the authentication application communicates directly with the authentication server 30 to register the authentication device 20 with the user's account. To complete the registration process, the authentication application on the authentication device creates a pair of public and private keys. The authentication device sends its public key along with its one or more pieces of addition information—including GPS information, location information of WiFi, cell tower info that the authentication device communicates with, latent signals, Mac ID, WiFi Mac ID, WiFi Network SSID, Bluetooth Low Energy Mac ID, nearby BLE Devices Mac ID, SSID, hardware information of the authentication device, IMEI, operating system, operating system version, screen resolution, touch screen pattern while users was using the authentication device, user behavior including motion sensors information, phone number of the authentication device, whether the authentication device is jailbroken/rooted, and a like—to the authentication server. This completes the initial setup for the fourth embodiment.

The browsing device 10 and the authentication device 20 do not need to communicate directly, as a result, the browsing device 10 does not need to download extra program(s) or plugin(s). An embodiment of the present invention also allows the user to get authenticated or authorize activities that are done on different browsing devices 10. The number of browsing device 10 can be unlimited or limited based on desirable level of security.

At the conclusion of 1017, whenever the user authenticates, he/she will no longer authenticate using their old authentication method (as described in step 1011). Instead the user will provide their biometric information to be authenticated locally to the authentication device.

### Authentication Process

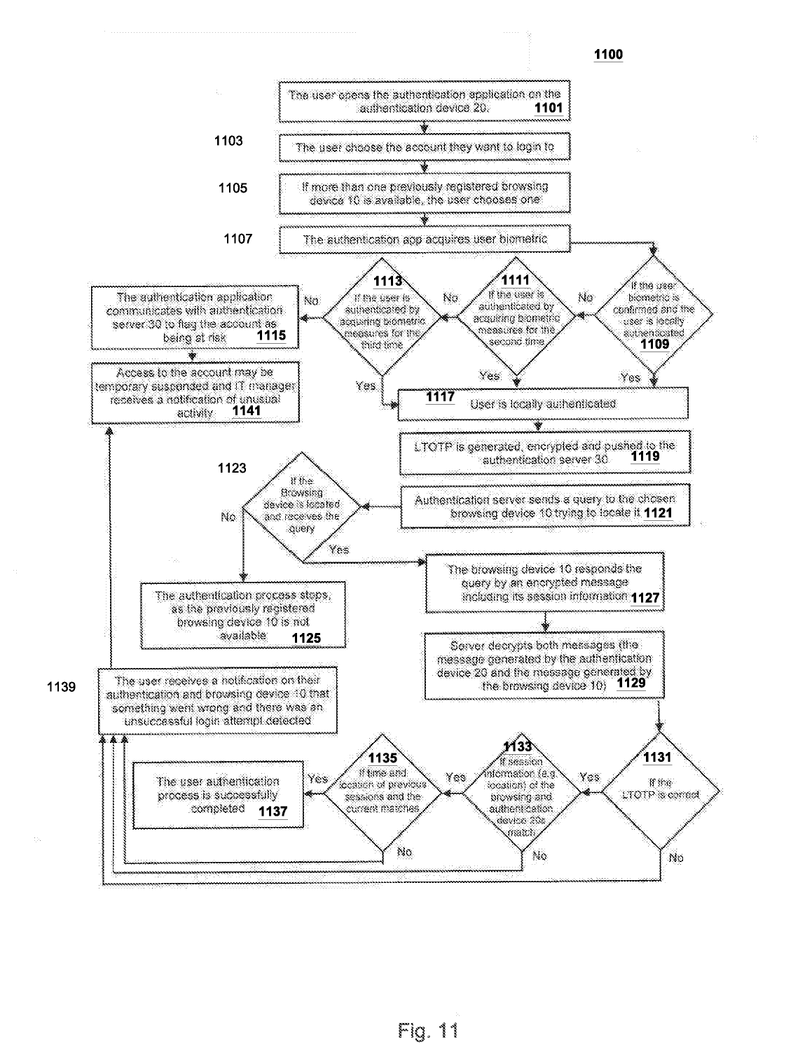

FIG. 11 illustrates process 1100 for user authentication after the initial set up is completed according to the fourth embodiment. As previously mentioned, in this embodiment, there is no need to pair the browsing device 10 and the authentication device 20 and they do not communicate directly.

At 1011, every time that user wants to take an action on his/her browsing device 10 that requires authentication or authorization—for instance, log into an application, online account, webpage, and the like—the user starts with opening up the authentication application on the authentication device 20.

At 1103, if the user uses the authentication application to get authenticated or authorize activities on more than one account, website, application, could service, VPN, and the like, the next for the user is to choose the account, website, application, could service, VPN, and the like that the user needs to be authenticated for.

At 1105, if the user previously used or registered more than one browsing device 10 to be authenticated on, the authentication application also allows the user to choose which browsing device 10 is used for the current session.

At 1107, once a browsing device 10 is chosen, the authentication application acquires the user's biometric information. No matter if the authentication device 20 has a screen lock activated that asks for biometric information to unlock the screen or not, once the user reaches this, the authentication application acquires user biometric information. Based on the operating system and hardware available on authentication device 20, the authentication application may acquire different types of biometric information such as fingerprint, voice, face image, finger geometry, heart ECG biometric, vein patterns, Iris pattern, and the like.

At 1109, if the result of local authentication is not positive the first time, the user may be given more chances to try (i.e. 1111-1113). Based on the desired level of security, IT administration may set the number of time that a user can try to get locally authenticated through getting biometric information. FIG. 11 shows that the user may be given two more chance if the first one fails.

After the preset number of times (for instance three in FIG. 11), if the user is not locally authenticated on the authentication device 20 based on biometric information then the process moves to 1115 and the authentication device 20 communicates directly with the authentication server 30 to report unsuccessful local authentication process. This flags the account and/or the username as being at risk which may result in limiting access to the account, webpage, application, software, and the like or—temporary or permanently—suspending any actions that needs user's authentication or authorization.

At 1117, if the user local authentication process via checking biometric information is successfully completed. At 1119, the authentication device 20 generates first a Location and Time based One Time Password (LTOTP). Then it creates an encrypted message for the authentication server including additional information—such as GPS information, location information of Wifi, cell tower info that the authentication device communicates with, latent signals, Mac ID, WiFi Mac ID, WiFi Network SSID, Bluetooth Low Energy Mac ID, nearby BLE Devices Mac ID, SSID, hardware information of the authentication device, IMEI, operating system, operating system version, screen resolution, touch screen pattern while users was using the authentication device, user behavior including motion sensors information, phone number of the authentication device, whether the authentication device is jailbroken/rooted, and the like—chosen account, chosen browsing device 10 (if relevant), LTOTP, and sends it to the authentication server 30.

At step 1121, the authentication server 30 decrypts the received message from the authentication device 20. Then, the authentication server 30 sends a query to the browsing device 10 (or the chosen browsing device) to locate the browsing device. If the authentication server 30 fails to locate the browsing device 10, the authentication process 1100 stops since the authentication server 30 is not able locate the device and access to the account is not granted. Repetition this incident will flag the account as being at risk and may result in temporary suspension of access to the account.

Alternatively if the authentication server 30 succeeds in locating the browsing device 10, at 1127, the browsing device 10 responds to the authentication server 30 query with an encrypted message that includes the browsing device 10 information including the type of device, device name, Mac ID, session information (i.e. hardware information, browser name, browser version, operating system, operating system version, IP address, agent operating system, browser size, hardware information), session ID and the like.

At 1129, the authentication server 30 decrypts the encrypted messages received from two devices (message generated by the authentication device 20 and the browsing device 20). At 1131, the authentication server checks the LTOTP. If this does not matches the one-time Password—based on time and location of the authentication device 20—that is created by the algorithm running on the authentication server, the account and/or the username is flagged as being at risk. This may result in limiting access to the account, webpage, application, software, and the like, or—temporary or permanently—suspending any actions that needs users' authentication or authorization. The server may also sends a notification to the user on his/her browsing device 10 and/or authentication device 20 informing the user that an unusual activities has been detected.

If the LTOTP is what the server expected and matches the one generated by the algorithm running on the authentication server 30, then, at 1133, the server compares the browsing device 10 information with information received from the authentication device 20. If these two sets of information do not match, the server detects another risk to the account. This flags the account and/or the username as being at risk which may result in limiting access to the account, webpage, application, software, and the like or—temporary or permanently—suspending any actions that needs user's authentication or authorization.

If the information received from the browsing device 10 and the information received from the authentication device 20 match, then at step 1135, then the authentication server 30 checks the details of the current session—including GPS information, location information of Wifi, cell tower info that the authentication communicates with, latent signals, Mac ID, WiFi Mac ID, WiFi Network SSID, Bluetooth Low Energy Mac ID, nearby BLE Devices Mac ID, SSID, hardware information of the device, IMEI, operating system, operating system version, screen resolution, touch screen pattern while users was using the authentication device, user behavior including motion sensors information, phone number of the authentication, whether the phone is jailbroken/rooted, and a like—with details from the previous sessions. If the information from current session is not dramatically different from the previous session and the fraud detection machine-learning algorithm that is run on the authentication server 30 does not detect any unusual activities, the authentication process is successfully completed. This completes the authentication or authorization process and, for instance, the user is granted access to log into the desired account, website, application, cloud serve, VPN, and the like. If the machine-learning algorithm detects any unusual activity or the time and location previous session varies significantly from the current session, the authentication server 30 flags the account and/or the username as being at risk which may result in limiting access to the account, webpage, application, software, and the like or—temporary or permanently—suspending any actions that needs user's authentication or authorization.

Checking the location and time of the previous sessions with the current session allows the authentication server 30 to detect any dramatic changes in the location. If the user request for authentication or authorization at the certain point at time and a location and then later the authentication server 30 receives another request from the same user but at a location that the user could not travel to the new location since the last time the user sent the authentication request, then this may indicate an unusual activity. An embodiment of the present invention also enables the authentication server 30 to automatically monitor all users' session information location and time in order to detect unusual activity or session. An embodiment of the present invention also enables the authentication server 30 to limit the access to every account only to one session at a time. An embodiment of the present invention enables the authentication server 30 to limit access to one account to one certain device as the authentication device 20 and one certain device as the browsing device 10 if it is desirable.

If the information received from the browsing device 10 and the information received from the authentication device 20 match, the authentication process is successfully completed. This complete the authentication or authorization process; for instance, the user is granted access to log into the desired account, website, application, cloud server, VPN, and the like.

As suggested in the previously , to improve the security, an embodiment of the present invention provides the authentication program that runs on the authentication server 30 may to be set to deny access to any request coming from a high risk area or the area that the user is not expected to login from. An embodiment of the present invention provides that the authentication program—running on the server—is able to limit the user to be able to be authenticated only from certain geographic areas and at certain times. An embodiment of the present invention also able to exclude login from certain geographic areas and/or certain times, so any authentication requests from those areas are not authorized and the associated account is flagged as being at risk.

### Logout Option

Since the authentication device 20 and the browsing device 10 do not communicate directly, as was the case in the third embodiment, the walk-out logout option provided in the first two embodiments would not be available. However, as mentioned in the third embodiment, it is possible to set up walk-out logout feature by setting up a communication channel between the two devices (the authentication device 20 and the browsing device 10) via any number of protocols or techniques. For example, beacon of Bluetooth may be use to figure out whether the authentication device 20 is in proximity of the browsing device 10. In the third embodiment, other application applicable solution were provided such as using GPS data and motion sensors data on the authentication device 20 to detect when the user walks away from the browsing device 10 carrying the authentication device 20.

Embodiments of the invention, also provides having a logout button on the authentication application installed on the authentication device 20, so the user can end the session that they are authenticated for from the authentication device 20.

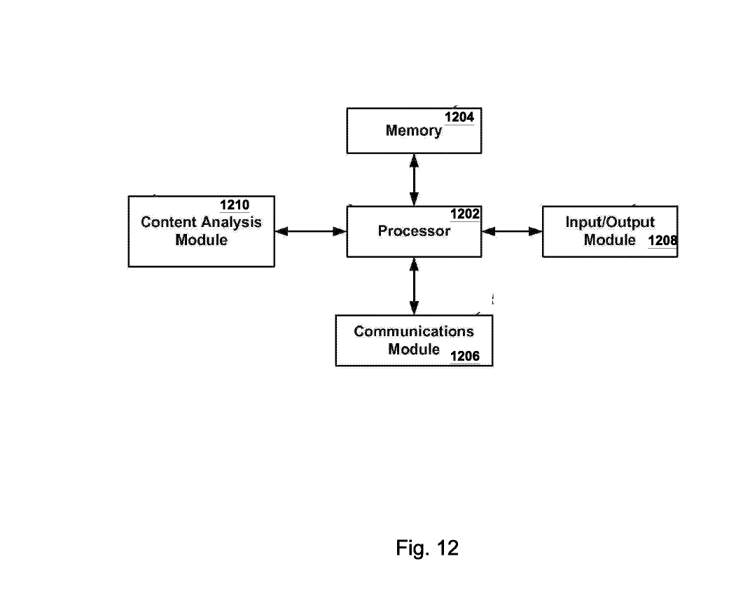

FIG. 12 shows a schematic block diagram of circuitry 1200, some or all of which may be included in, for example, authentication device 20, browsing device 10, and/or authentication server 30. As illustrated in FIG. 125, in accordance with some example embodiments, circuitry 1200 can include various means, such as processor 1202, memory 1204, communications module 1206, and/or input/output module 1208. As referred to herein, “module” includes hardware, software and/or firmware configured to perform one or more particular functions. In this regard, the means of circuitry 1200 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 1204) that is executable by a suitably configured processing device (e.g., processor 1202), or some combination thereof.

Processor 1202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 5 as a single processor, in some embodiments processor 1202 comprises a plurality of processors. The plurality of processors may be embodied on a single computing device or may be distributed across a plurality of computing devices collectively configured to function as circuitry 1200. The plurality of processors may be in operative communication with each other and may be collectively configured to perform one or more functionalities of circuitry 1200 as described herein. In an example embodiment, processor 1202 is configured to execute instructions stored in memory 1204 or otherwise accessible to processor 1202. These instructions, when executed by processor 1202, may cause circuitry 1200 to perform one or more of the functionalities of circuitry 1200 as described herein.

Whether configured by hardware, firmware/software methods, or by a combination thereof, processor 1202 may comprise an entity capable of performing operations according to embodiments of the present invention while configured accordingly. Thus, for example, when processor 1202 is embodied as an ASIC, FPGA or the like, processor 1202 may comprise specifically configured hardware for conducting one or more operations described herein. Alternatively, as another example, when processor 1202 is embodied as an executor of instructions, such as may be stored in memory 1204, the instructions may specifically configure processor 1202 to perform one or more algorithms and operations described herein, such as those discussed in connection with FIGS. 1-11.

Memory 1204 may comprise, for example, volatile memory, non-volatile memory, or some combination thereof. Although illustrated in FIG. 5 as a single memory, memory 1204 may comprise a plurality of memory components. The plurality of memory components may be embodied on a single computing device or distributed across a plurality of computing devices. In various embodiments, memory 1204 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 1204 may be configured to store information, data (including analytics data), applications, instructions, or the like for enabling circuitry 1200 to carry out various functions in accordance with example embodiments of the present invention. For example, in at least some embodiments, memory 1204 is configured to buffer input data for processing by processor 1202. Additionally or alternatively, in at least some embodiments, memory 1204 is configured to store program instructions for execution by processor 1202. Memory 1204 may store information in the form of static and/or dynamic information. This stored information may be stored and/or used by circuitry 1200 during the course of performing its functionalities.

Communications module 1206 may be embodied as any device or means embodied in circuitry, hardware, a computer program product comprising computer readable program instructions stored on a computer readable medium (e.g., memory 1204) and executed by a processing device (e.g., processor 1202), or a combination thereof that is configured to receive and/or transmit data from/to another device, such as, for example, a second circuitry 1200 and/or the like. In some embodiments, communications module 1206 (like other components discussed herein) can be at least partially embodied as or otherwise controlled by processor 1202. In this regard, communications module 1206 may be in communication with processor 1202, such as via a bus. Communications module 1206 may include, for example, an antenna, a transmitter, a receiver, a transceiver, network interface card and/or supporting hardware and/or firmware/software for enabling communications with another computing device. Communications module 1206 may be configured to receive and/or transmit any data that may be stored by memory 1204 using any protocol that may be used for communications between computing devices. Communications module 1206 may additionally or alternatively be in communication with the memory 1204, input/output module 1208 and/or any other component of circuitry 1200, such as via a bus.

Input/output module 508 may be in communication with processor 502 to receive an indication of a user input and/or to provide an audible, visual, mechanical, or other output to a user. Some example visual outputs that may be provided to a user by circuitry 1200 are discussed in connection with FIG. 1. As such, input/output module 1208 may include support, for example, for a keyboard, a mouse, a joystick, a display, a touch screen display, a microphone, a speaker, a RFID reader, barcode reader, biometric scanner, and/or other input/output mechanisms. In embodiments wherein circuitry 1200 is embodied as a server or database, aspects of input/output module 1208 may be reduced as compared to embodiments where circuitry 1200 is implemented as an end-user machine or other type of device designed for complex user interactions. In some embodiments (like other components discussed herein), input/output module 1208 may even be eliminated from circuitry 1200. Alternatively, such as in embodiments wherein circuitry 1200 is embodied as a server or database, at least some aspects of input/output module 1208 may be embodied on an apparatus used by a user that is in communication with circuitry 1200. Input/output module 1208 may be in communication with the memory 1204, communications module 1206, and/or any other component(s), such as via a bus. Although more than one input/output module and/or other component can be included in circuitry 1200, only one is shown in FIG. 12 to avoid overcomplicating the drawing (like the other components discussed herein).

Content analysis module 1210 may also or instead be included and configured to perform the functionality discussed herein related to the identification of authentication of a user as discussed above. In some embodiments, some or all of the functionality of content analysis may be performed by processor 1202. In this regard, the example processes and algorithms discussed herein can be performed by at least one processor 1202 and/or content analysis module 1210. For example, non-transitory computer readable media can be configured to store firmware, one or more application programs, and/or other software, which include instructions and other computer-readable program code portions that can be executed to control each processor (e.g., processor 1202 and/or content analysis module 1210) of the components of system 100 to implement various operations, including the examples shown above. As such, a series of computer-readable program code portions are embodied in one or more computer program products and can be used, with a computing device, server, and/or other programmable apparatus, to produce machine-implemented processes.

For example, content analysis module 1210 can be configured to match acquired biometric information with stored biometric information, secure (i.e. encrypt) biometric information prior to storage in memory 1204, run algorithms in accordance with steps 321-325 as described above, etc . . . In this way, content analysis module 1210 may support multiple analysis algorithms, such as those discussed above, so that the selected algorithm may be chosen at runtime.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of system 100. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Embodiments of the present invention have been described above with reference to block diagrams and flowchart illustrations of methods, apparatuses, systems and computer program products. It will be understood that each block of the circuit diagrams and process flow diagrams, and combinations of blocks in the circuit diagrams and process flowcharts, respectively, can be implemented by various means including computer program instructions. These computer program instructions may be loaded onto a general purpose computer, special purpose computer, or other programmable data processing apparatus, such as processor 1202 and/or content analysis module 1210 discussed above with reference to FIG. 12, to produce a machine, such that the computer program product includes the instructions which execute on the computer or other programmable data processing apparatus create a means for implementing the functions specified in the flowchart block or blocks.

These computer program instructions may also be stored in a computer-readable storage device (e.g., memory 1204) that can direct a computer or other programmable data processing apparatus to function in a particular manner, such that the instructions stored in the computer-readable storage device produce an article of manufacture including computer-readable instructions for implementing the function discussed herein. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions discussed herein.

Accordingly, blocks of the block diagrams and flowchart illustrations support combinations of means for performing the specified functions, combinations of steps for performing the specified functions and program instruction means for performing the specified functions. It will also be understood that each block of the circuit diagrams and process flowcharts, and combinations of blocks in the circuit diagrams and process flowcharts, can be implemented by special purpose hardware-based computer systems that perform the specified functions or steps, or combinations of special purpose hardware and computer instructions

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method of authenticating a user comprising:
receiving a request from the user to access an account via a first device associated with the user;
acquiring biometric data from the user on a second device; and
granting access to the account if the acquired biometric data matches biometric data stored in the second device.

2. The method of claim 1 further comprising:
detecting whether the second device is in proximity of the first device; and
granting access to the account if the second device is in proximity of the first device.

3. The method of claim 1 further:
generating a first encrypted message via the second device;
decrypting the first encrypted message via a third device; and
granting access to the account based on the decrypted message.

4. The method claim 1 wherein the first encrypted message comprises a randomly generated time and location based one-time password that is generated based on a location of the second device.

5. The method of claim 1 further comprising:
determining a first set of session information related to the first device;
determining a second set of session information related to the second device; and
granting access to the account based upon a comparison of the first set of session information and the second set of session information

6. The method of claim 1 further comprising:
determining session information related to a current session;
determining session information related to a previous session; and
granting access the account based upon a comparison of the session information related to a current session and the session information related to a previous session.

7. The method of claim 2, further comprising:
terminating access to the account if the second device is detected as not being in proximity of the first device.

8. The method of claim 3, further comprising:
generating a second encrypted message via the second device, wherein the second encrypted message is distinct from the first encrypted message; and
decrypting the second encrypted message via the first device.

9. The method of claim 8, wherein the second encrypted message comprises account information related to the account.

10. The method of claim 8 further comprising:
generating a third encrypted message via the second device, wherein the third encrypted message is distinct from the first and second encrypted messages;
decrypting the third encrypted message via the third device; and
granting access to the account based upon the decrypted third encrypted message.

11. The method of claim 1, wherein the acquired biometric data is only stored on the second device.

12. The method of claim 1, wherein the first and second device are the same device.

13. The method of claim 1, wherein biometric data comprises at least one or more of the following: fingerprint data, voice data, face image data, finger geometry data, heart ECG biometric data, vein patterns data, and Iris pattern data.

14. The method of claim 2, wherein proximity is determined via a third device, wherein the third device is distinct from the first and second devices.

15. A computing device comprising a central processing unit and a memory for storing instructions which when executed by the computer processing unit causes the computer processing unit to:
receive a request to access an account;
receive a notification from a server associated with the account to instruct a user associated with the computing device to submit biometric information to the computing device to acquire a biometric data;
compare the acquired biometric data to stored biometric data on the computing device to detect a match;
generate and send an encrypted message to the server if the match is detected.

16. The computing device of claim 15, wherein the encrypted message comprises a randomly generated time and location based one-time password that is generated based on a location of the second device.

17. The computing device of claim 15, wherein biometric data comprises at least one or more of the following: fingerprint data, voice data, face image data, finger geometry data, heart ECG biometric data, vein patterns data, and Iris pattern data.

18. A server comprising a central processing unit and a memory for storing instructions which when executed by the central processing unit causes the central processing unit to:
cause a notification to be sent to a handheld device associated with a user attempting to gain access to a site; and
receive an encrypted message when the user's biometric information as acquired on the handheld device matches the biometric data previously stored on the handheld device.

19. The server of claim 17, wherein the encrypted message comprises a randomly generated time and location based one-time password that is generated based on a location of the second device.

20. The server of claim 17, wherein biometric data comprises at least one or more of the following: fingerprint data, voice data, face image data, finger geometry data, heart ECG biometric data, vein patterns data, and Iris pattern data.
